(19) United States
(12) Patent Application Publication
(10) Pub. No.: US 2012/0038853 A1
(43) Pub. Date: Feb. 16, 2012

(54) DISPLAY DEVICE, DISPLAY APPARATUS FOR DISPLAYING 3D IMAGE AND METHOD FOR CHANGING POLARIZATION DIRECTION OF LIGHT EMITTED FROM LIQUID CRYSTAL DISPLAY DEVICE

(75) Inventors: Wei-Tu TSAI, Miao-Li County (TW); Chi-Wei CHEN, Miao-Li County (TW)

(73) Assignee: CHIMEI INNOLUX CORPORATION, Miao-Li County (TW)

(21) Appl. No.: 13/164,509

(22) Filed: Jun. 20, 2011

(30) Foreign Application Priority Data
Aug. 12, 2010 (TW) 99127000
Dec. 3, 2010 (CN) 201010571862.1

(51) Int. Cl. G02F 1/1335

(52) U.S. Cl. 349/96

(57) ABSTRACT

A display device, a display apparatus for displaying a 3D image and a method for changing the polarization direction of a light emitted from a liquid crystal display device are provided. The display device comprises a liquid crystal display device and an optical film. The liquid crystal display device comprises a display panel and a polarizer. The polarizer is disposed on the display panel. The optical film is disposed on the polarizer and for changing the polarization direction of a light emitted from the polarizer.

This application claims the benefit of Taiwan application Serial No. 099127000, filed Aug. 12, 2010, the subject matter of which is incorporated herein by reference.

### BACKGROUND OF THE INVENTION

1. Field of the Invention

The invention relates in general to a display device and a method for changing the polarization direction of a light emitted from the display device, and more particularly to a display apparatus for displaying a 3D image and a method for changing the polarization direction of a light emitted from the display device.

2. Description of the Related Art

The three-dimensional (3D) display technology mainly projects the image lights of a left eye frame and a right eye frame for forming a 3D image onto the viewer's left eye and right eye respectively, so that a 3D image can be constructed in the viewer's brain. According to a commonly used method, the viewer wears a specific pair of glasses, such as color filter glasses, polarizing glasses, shutter glasses, which achieves the 3D image effect by making the viewer's left eye and right eye receive different image light respectively.

FIG. 1 shows a conventional display apparatus for displaying a 3D image. FIG. 2 shows an explosion diagram of a conventional the liquid crystal display device shown in FIG. 1. FIG. 3 shows an explosion diagram of a viewing window of conventional shutter glasses shown in FIG. 1. Referring to FIG. 1 and FIG. 2, the display apparatus for displaying a 3D image comprises a liquid crystal display device 1 and a pair of shutter glasses 11. The liquid crystal display device 1 comprises a display panel 2 and a light source 3. The display panel 2 comprises a pair of separate substrates 4 and 5, and a liquid crystal layer 6 including liquid crystal molecules interposed between the inner sides of the substrates 4 and 5, wherein the titled direction of the liquid crystal molecules in the liquid crystal layer 6 can be changed via controlling the electrical field between the substrates 4 and 5. Two polarizers 7 and 8 are respectively adhered onto the outer sides of the two substrates 4 and 5, and the optical axes of the two polarizers 7 and 8 are vertically arranged. The optical axis of the polarizer 7 close to the light source 3 filters the light source according to the polarization of the incident light and generates a linear polarized light which enters the display panel 2 and then is changed the polarization along with the liquid crystal layer 6. The transmissibility of the linear polarized light with respect to the polarizer 8 determines brightness level so as to achieve the display effect in the viewer's eyes. In other words, if the polarization direction of the incident light through the liquid crystal layer 6 is identical to the optical axis direction of the polarizer 8, then the incident light will be almost 100% transmitted. If the polarization direction of the incident light through the liquid crystal layer 6 is perpendicular to the optical axis direction of the polarizer 8, then the incident light will be 100% absorbed by the polarizer 8. If the angle between the polarization direction of the incident light through the liquid crystal layer 6 and the optical axis direction of the polarizer 8 is between 0 degree and 90 degrees, then the incident light will be partly absorbed by the polarizer 8 and partly transmitted. The liquid crystal display device 1 has different types, such as twisted nematic (TN) type and vertical alignment (VA) type, according to the choice of the liquid crystal layer 6. The two types, TN type and VA type, have different methods for driving the liquid crystal display device 1, and the optical properties vary accordingly. To provide a broader range of view angle for the viewer, when the liquid crystal display device 1 is realized by a TN type liquid crystal display device, the optical axis direction of the polarizer 8 is mostly 45 degrees or 135 degrees, and when the liquid crystal display device 1 is realized by a VA type liquid crystal display device, the optical axis direction of the polarizer 8 is mostly 0 degree or 90 degrees.

Referring to FIG. 1 and FIG. 3. For a viewer to feel a 3D image, the liquid crystal display device 1 will alternately display image light on the display panel 2 for the left eye and the right eye respectively. The pair of shutter glasses 11 comprises a left eye (L) viewing window 19 and a right eye (R) viewing window 19, wherein each of the viewing windows 19 comprises a liquid crystal panel 12, and each liquid crystal panel 12 also comprises a pair of separate substrates 14 and 15, and a liquid crystal layer 16 whose titled direction can be changed via controlling the electrical field between the substrates 14 and 15. Two polarizers 17 and 18 are respectively adhered onto the outer sides of the two substrates 14 and 15. Moreover, the optical axes of the two polarizers 17 and 18 are vertically arranged. By changing the alignment of the liquid crystal layer 16 of the liquid crystal panel 12 to control the image light emitted from the liquid crystal display device 1 can transmit the polarizer 17. The viewer will view a 3D image by way of the following arrangements. According to the state of the left eye image and the right eye image which displayed on the liquid crystal display device 1, the left eye image can be passed through the left eye (L) viewing window 19 at one time with the right eye (R) viewing window 19 is opaque, so that the viewer's left eye can receive the left eye image only but not the right eye image. At the next time, the right eye image can be passed through the right eye (R) viewing window 19 at another time, and the left eye (L) viewing window 19 is opaque so that the viewer's right eye can receive the right eye image only but not the left eye image.

In the liquid crystal display device 1, various liquid crystal types go with various optical axis directions of the polarizer 8. The optical axis direction of the polarizer 18 of the shutter glasses 11 must be identical to that of the polarizer 8, otherwise, brightness loss will be occurred.

For a viewer, it is inconvenient to prepare various shutter glasses to go with various types of liquid crystal display device. Furthermore, the shutter glasses are expensive and will discourage consumers' willingness in purchase.

### SUMMARY OF THE INVENTION

Embodiments of the present disclosure is directed to a display device, a display apparatus for displaying a 3D image and a method for changing the polarization direction of a light emitted from a liquid crystal display device for enabling the viewer to watch the display frame displayed on different types of liquid crystal display devices with one set of viewing device only and at the same time maintaining the same level of brightness.

According to a first aspect of the present invention, a display device is provided. The display device comprises a liquid crystal display device and an optical film. The liquid crystal display device comprises a display panel and a polarizer. The polarizer is disposed on the display panel. The optical film is disposed on the polarizer and for changing a polarization direction of a light emitted from the polarizer.

According to a second aspect of the present invention, a display apparatus for displaying a 3D image is provided. The display apparatus for displaying a 3D image comprises a liquid crystal display device, a half wave plate and a viewing device. The liquid crystal display device comprises a display panel and a first polarizer. The first polarizer is disposed on the display panel. The half wave plate is disposed on the first polarizer and for changing a polarization direction of a light emitted from the first polarizer. The viewing device comprises two viewing windows, and a surface of each of the viewing windows has a second polarizer.

According to a third aspect of the present invention, a method for changing a polarization direction of a light emitted from a liquid crystal display device is provided. The liquid crystal display device comprises a display panel and a polarizer. The polarizer is disposed on the display panel. The method comprises: disposing an optical film on the polarizer. The optical film is used for changing the polarization direction of a light emitted from the polarizer.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a conventional display apparatus for displaying a 3D image;

FIG. 2 shows an explosion diagram of a conventional the liquid crystal display device;

FIG. 3 shows an explosion diagram of a viewing window of conventional shutter glasses;

FIG. 4 shows a display apparatus for displaying a 3D image according to an embodiment of the invention;

FIG. 5 shows display apparatus for displaying a 3D image of a first example;

FIG. 6 shows display apparatus for displaying a 3D image of a second example;

FIG. 7 shows display apparatus for displaying a 3D image of a third example;

FIG. 8 shows display apparatus for displaying a 3D image of a fourth example;

FIG. 9 shows display apparatus for displaying a 3D image of a fifth example;

FIG. 10 shows display apparatus for displaying a 3D image of a sixth example;

FIG. 11 shows display apparatus for displaying a 3D image of a seventh example;

FIG. 12 shows display apparatus for displaying a 3D image of a eighth example; and

FIG. 13 shows a cross-sectional view of a display device according to an embodiment of the invention.

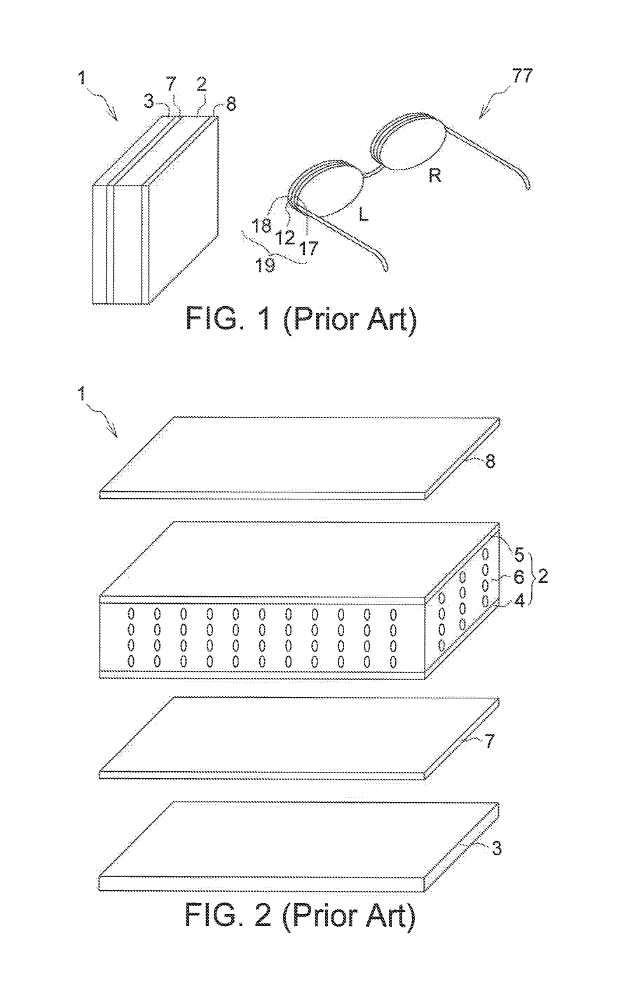

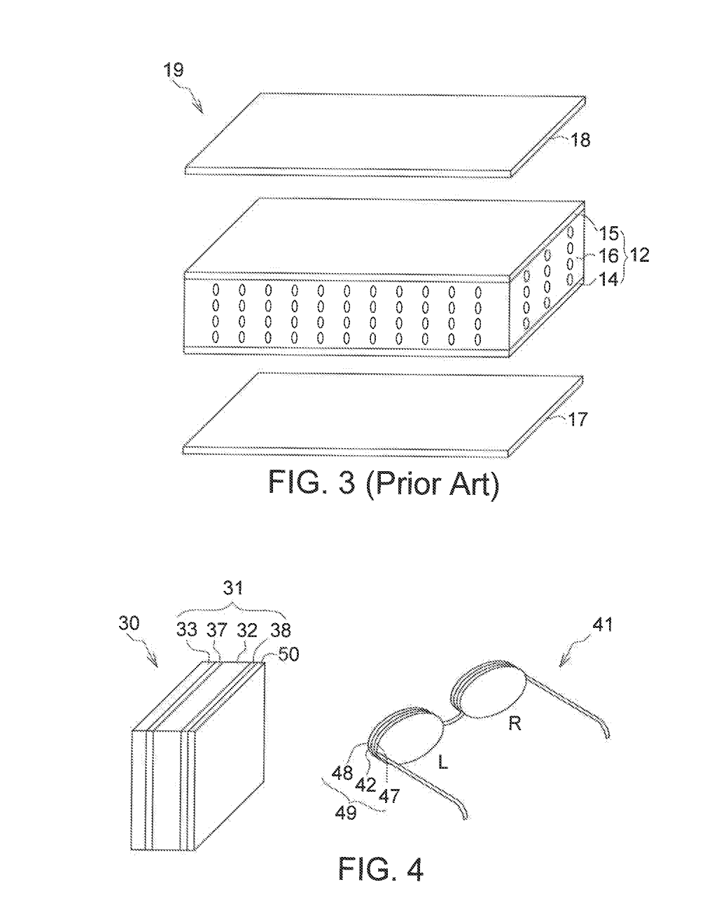

### DETAILED DESCRIPTION OF THE INVENTION

FIG. 4 shows a display apparatus for displaying a 3D image according to an embodiment of the invention. The display apparatus for displaying a 3D image comprises a display device 30 and a viewing device 41. The display device 30 comprises a liquid crystal display device 31 and an optical film 50. As similar disclosed in the prior art, the liquid crystal display device 31 may comprise, for example, a light source 33, a display panel 32 and polarizers 37 and 38. As similar disclosed in the prior art, left eye (L) and right eye (R) viewing windows 49 of the viewing device 41 may comprise, for example, a liquid crystal panel 42 and polarizers 47 and 48. The optical axis direction (that is, the polarization direction that is light transmissible) of the polarizer 48 of the left eye (L) viewing window 49 is identical to that of the right eye (R) viewing window 49. The viewing device 41 may comprise a pair of shutter glasses for example.

The optical film 50 is used for changing the linear polarization direction of the light emitted from the polarizer 38. The optical film 50 may comprise a retardation film, such as a half wave plate. In a preferred embodiment, the optical film 50 is realized by a single-layered half wave plate such as polycarbonate (Manufacturer: Teijin Chemicals Ltd; Product Name: GR-270). The optical film 50 can also be realized by a multi-layered half wave plate. Since the light source 33 used in the liquid crystal display device 31 emits a visible light whose wave band ranges from 380 nm to 780 nm, the optical film 50 can be realized by a broadband half wave plate, such as cyclic olefin polymer (COP) (Manufacturer: Nitto Denko; Product Name: NZF-270). The optical film 50 can produce the same change in the polarization direction with respect to a wide range of wave band. Therefore, color offset occurring as the lights of some wave bands are changed to different polarization directions can be avoided.

In one embodiment, the optical film 50 is a half wave plate, which changes the linear polarization direction of the light penetrating the half wave plate to another linear polarization direction. Referring to FIG. 4, for changing the polarization direction of the light emitted from the polarizer 38 to an polarization direction corresponding to the optical axis of the polarizer 48 for avoiding the deterioration in the image brightness viewed by the viewer, the optical axis of the optical film 50 and the optical axis of the polarizer 38 are arranged to have an optical angle therebetween. The optical angle is preferably a half of an angle that the optical axis of the polarizer 38 and the optical axis of the polarizer 48 have therebetween. Thus, the angle that the optical axis of the optical film 50 and the optical axis of the polarizer 38 have therebetween is substantially identical to the angle that the optical axis of the optical film 50 and the optical axis of the polarizer 48 have therebetween.

Since the polarization direction of the light emitted from the polarizer 38 of the liquid crystal display device 31 can be changed to the optical axis corresponding to the optical axis of the polarizer 48 by the optical film 50, a user does not need to use a predetermined combination of the liquid crystal display device 31 and the viewing device 41. The optical film 50 adapted to the properties of the viewing device 41 owned by a user can be adhered onto the liquid crystal display device 31 to achieve excellent display effect.

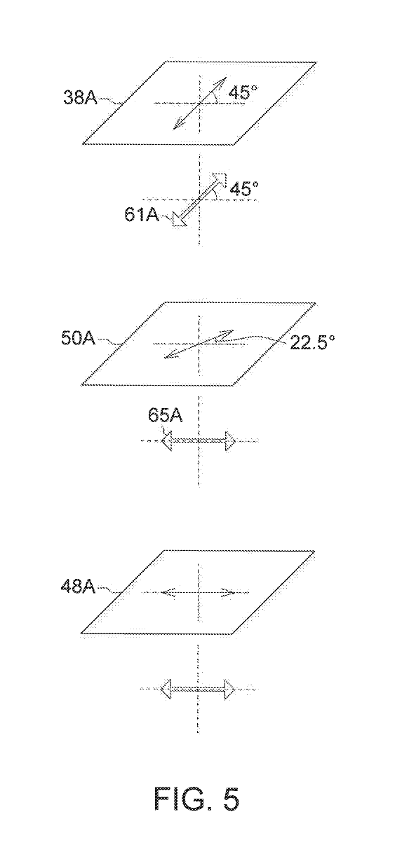

FIGS. 5 to 12 respectively show a display apparatus for displaying a 3D image of other examples. In FIGS. 5 to 12, the polarizers 38A, 38B, 38C, 38D, 38E, 38F, 38G, and 38H are similar to the polarizer 38 shown in FIG. 4. The optical films 50A, 50B, 50C, 50D, 50E, 50F, 50G, and 50H are similar to the optical film 50 shown in FIG. 4. The polarizer 48A, 48B, 48C, 48D, 48E, 48F, 48G, and 48H are similar to the polarizer 48 shown in FIG. 4. For simplicity purpose, other elements are not illustrated in the diagrams.

Referring to FIG. 5, in the first example, the liquid crystal display device of the display apparatus for displaying a 3D image is realized by a TN type liquid crystal display device. The viewing device is realized by a pair of VA type shutter glasses for receiving the image light emitted from the VA type liquid crystal display device. The optical axis of the polarizer 38A disposed on the display panel of the TN type liquid crystal display device is 45 degrees and the optical axis of the polarizer 48A used in the VA type shutter glasses equals 0 degree which differs with the optical axis of the polarizer 38A on the display panel of the TN type liquid crystal display device by 45 degrees, so in this case the applicable optical film 50A is realized by a half wave plate whose optical axis is 22.5 degrees and forms a contained angle of 22.5 ((45−0)/2) degrees with the optical axis of the polarizer 38A. Thus, after the light 61A emitted from the polarizer 38A at a polarization direction of 45 degrees passes through the optical film 50A, the light 61A is converted into a light 65A having a polarization direction at 0 degree and corresponds to the optical axis of the polarizer 48A.

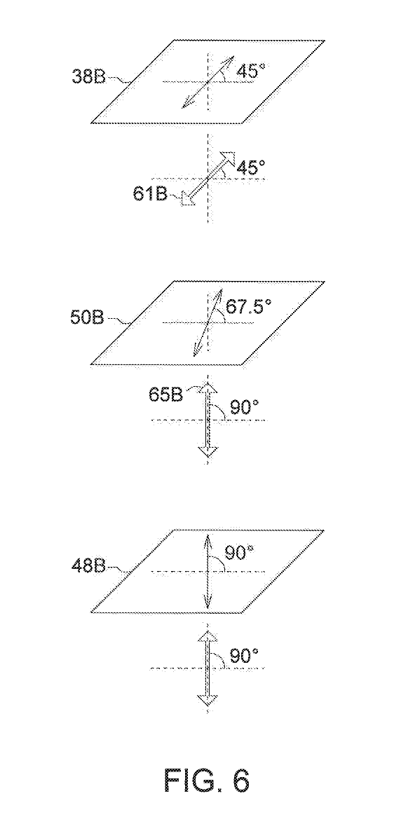

Likewise, in the second example, referring to FIG. 6, the liquid crystal display device is realized by a TN type liquid crystal display device. The viewing device is realized by a pair of VA type shutter glasses for receiving the image light emitted from the VA type liquid crystal display device. The optical axis of the polarizer 38B disposed on the display panel of the TN type liquid crystal display device is 45 degrees and the optical axis of the polarizer 48B used in the VA type shutter glasses equals 90 degrees, so in this case the applicable optical film 50B is realized by a half wave plate whose optical axis is 67.5 degrees and differs with the optical axis of the polarizer 38B by 22.5 (67.5−45 or (90−45)/2) degrees. Thus, after the light 61B emitted from the polarizer 38B at a polarization direction of 45 degrees passes through the optical film 50B, the light 61B is converted into a light 65B having a polarization direction at 90 degrees and corresponds to the optical axis of the polarizer 48B.

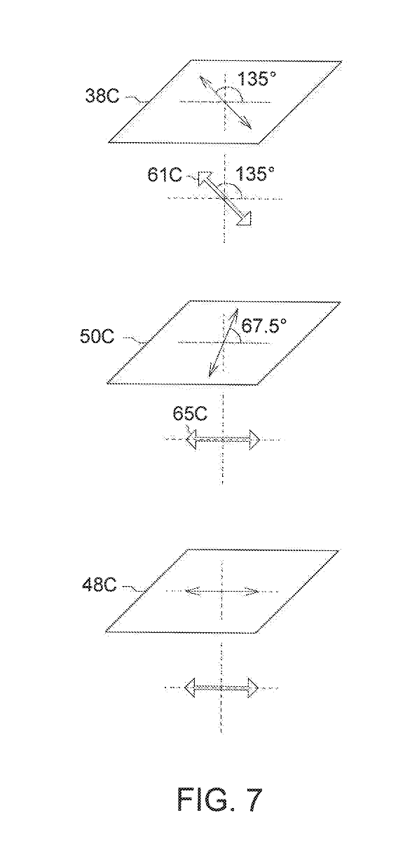

In the third example, referring to FIG. 7, the liquid crystal display device is realized by a TN type liquid crystal display device. The viewing device is realized by a pair of VA type shutter glasses for receiving the image light emitted from the VA type liquid crystal display device. The optical axis of the polarizer 38C disposed on the display panel of the TN type liquid crystal display device is 135 degrees, and the optical axis of the polarizer 48C used in the VA type shutter glasses equals 0 degree, so in this case the applicable optical film 50C is realized by a half wave plate whose optical axis is 67.5 degrees. Thus, after the light 61C emitted from the polarizer 38C at a polarization direction of 135 degrees passes through the optical film 50C, the light 61C is converted into a light 65C having a polarization direction at 0 degree and corresponds to the optical axis of the polarizer 48C.

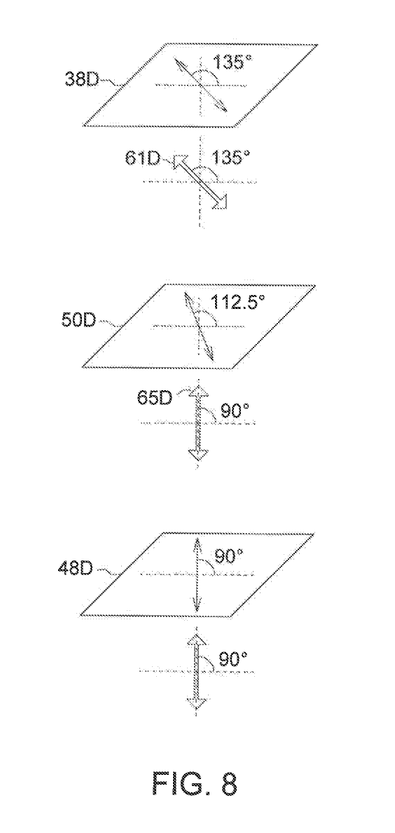

In the fourth example, referring to FIG. 8, the liquid crystal display device is realized by a TN type liquid crystal display device. The viewing device is realized by a pair of VA type shutter glasses for receiving the image light emitted from the VA type liquid crystal display device. The optical axis of the polarizer 38D disposed on the display panel of the TN type liquid crystal display device is 135 degrees, and the optical axis of the polarizer 48D used in the VA type shutter glasses equals 90 degrees, so in this case the applicable optical film 50D is realized by a half wave plate whose optical axis is 112.5 degrees. Thus, after the light 61D emitted from the polarizer 38D at a polarization direction of 135 degrees passes through the optical film 50D, the light 61D is converted into a light 65D having a polarization direction at 90 degrees and corresponds to the optical axis of the polarizer 48D.

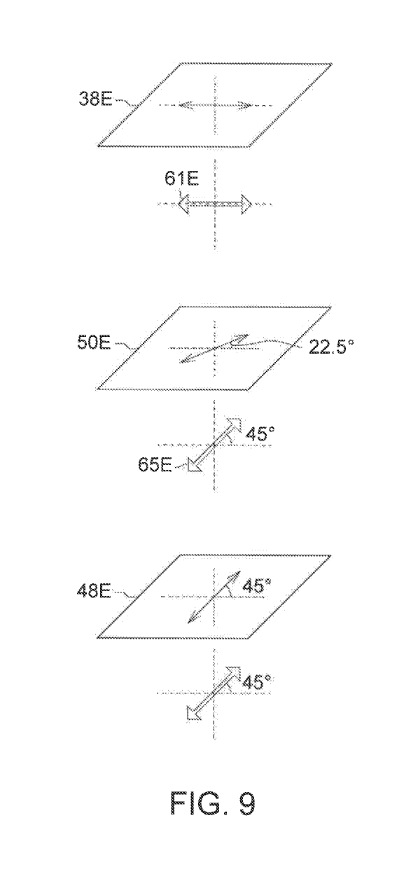

In the fifth example, referring to FIG. 9, the liquid crystal display device is realized by a VA type liquid crystal display device. The viewing device is realized by a pair of TN type shutter glasses for receiving the image light emitted from the TN type liquid crystal display device. The optical axis of the polarizer 38E disposed on the display panel of the VA type liquid crystal display device is 0 degree, and the optical axis of the polarizer 48E used in the TN type shutter glasses equals 45 degrees, so in this case the applicable optical film 50E is realized by a half wave plate whose optical axis is 22.5 degrees. Thus, after the light 61E emitted from the polarizer 38E at a polarization direction of 0 degree passes through the optical film 50E, the light 61E is converted into a light 65E having a polarization direction at 45 degrees and corresponds to the optical axis of the polarizer 48E.

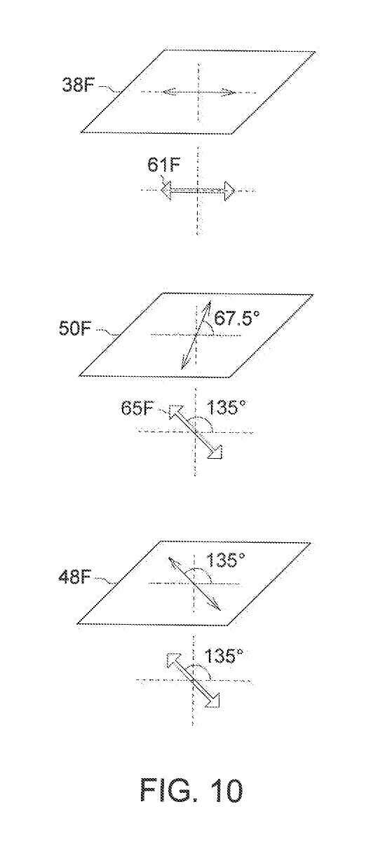

In the sixth example, referring to FIG. 10, the liquid crystal display device is realized by a VA type liquid crystal display device. The viewing device is realized by a pair of TN type shutter glasses for receiving the image light emitted from the TN type liquid crystal display device. The optical axis of the polarizer 38F disposed on the display panel of the VA type liquid crystal display device is 0 degree, and the optical axis of the polarizer 48F used in the TN type shutter glasses equals 135 degrees, so in this case the currently applicable optical film 50F is realized by a half wave plate whose optical axis is 67.5 degrees. Thus, after the light 61F emitted from the polarizer 38F at a polarization direction of 0 degree passes through the optical film 50F, the light 61F is converted into a light 65F having a polarization direction at 135 degrees and correspond to the optical axis of the polarizer 48F.

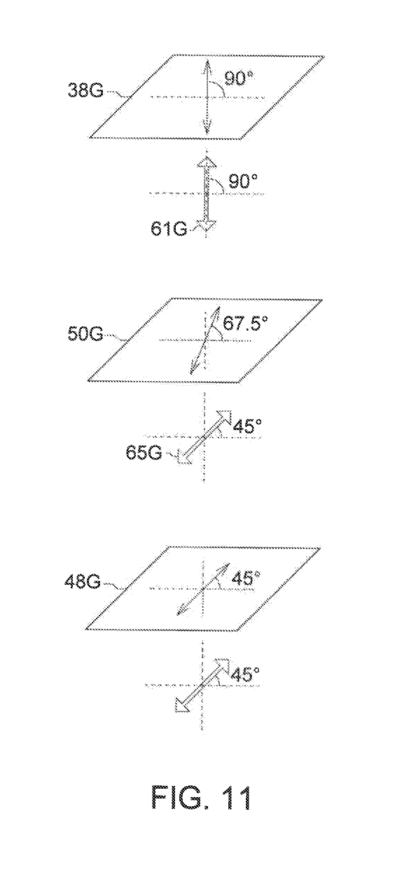

In the seventh example, referring to FIG. 11, the liquid crystal display device is realized by a VA type liquid crystal display device. The viewing device is realized by a pair of TN type shutter glasses for receiving the image light emitted from the TN type liquid crystal display device. The optical axis of the polarizer 38G disposed on the display panel of the VA type liquid crystal display device is 90 degrees, and the optical axis of the polarizer 48G used in the TN type shutter glasses equals 45 degrees, so in this case the applicable optical film 50G is realized by a half wave plate whose optical axis is 67.5 degrees. Thus, after the light 61G emitted from the polarizer 38G at a polarization direction of 90 degrees passes through the optical film 50G, the light 61G is converted into a light 65G having a polarization direction at 45 degrees and corresponding to the optical axis of the polarizer 48G.

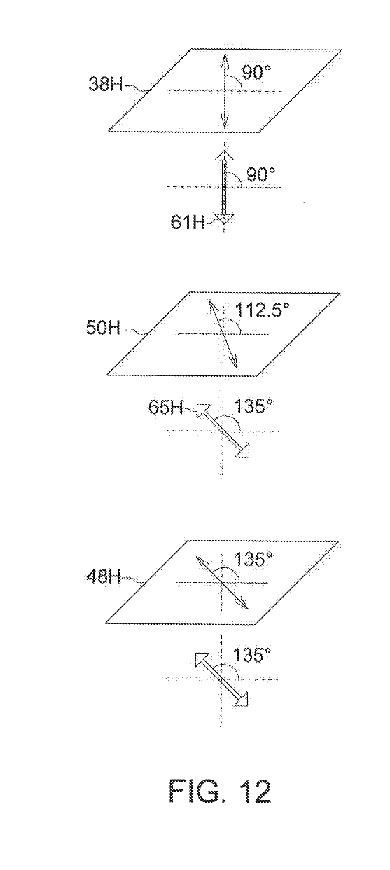

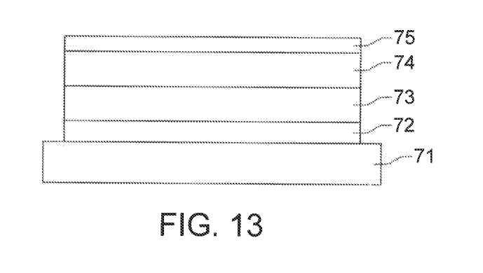

In the eighth example, referring to FIG. 12, the liquid crystal display device is realized by a VA type liquid crystal display device. The viewing device is realized by a pair of TN type shutter glasses for receiving the image light emitted from the TN type liquid crystal display device. The optical axis of the polarizer 38H disposed on the display panel of the VA type liquid crystal display device is 90 degrees, and the optical axis of the polarizer 48H used in the TN type shutter glasses equals 135 degrees, so in this case the applicable optical film 50H is realized by a half wave plate whose optical axis is 112.5 degrees. Thus, after the light 61H emitted from the polarizer 38H at a polarization direction of 90 degrees passes through the optical film 50H, the light 61H is converted into a light 65HG having a polarization direction at 135 degrees and corresponds to the optical axis of the polarizer 48H.

Nonetheless, the invention is not limited to the disposition and method described in the above embodiments, and can be adjusted to fit actual needs for changing the polarization direction of a light emitted from a liquid crystal display device to the direction corresponding to the polarization direction transmissible to the light of the viewing window of the viewing device.

FIG. 13 shows a cross-sectional view of a display device according to an embodiment of the invention. Referring to FIG. 13, the optical film 73 can be adhered onto a liquid crystal display device 71 by an adhesive layer 72. The adhesive layer 72 may comprise pressure sensitive adhesion (PSA). The optical film 73 may comprise a retardation film, such as a half wave plate. In a preferred embodiment, the optical film 73 is a single-layered half wave plate. The optical film 73 can also be realized by a multi-layered half wave plate or a broadband half wave plate. A base 74, which can be disposed on the optical film 73, may comprise triacetyl cellulose (TAC) which possesses great hardness for providing protection. The surface treatment layer 75, which can be disposed on the base 74, may comprise a foggy anti-glare (AG) film for reducing glare or a gloss (HC) film for enhancing contrast and making the frame more colorful.

According to the embodiments of the invention, the polarization direction of the image light is adjusted by the optical film disposed on the polarizer of the liquid crystal display device. Thus, the user can adjust the light properties emitted from the liquid crystal display device according to the owned viewing device, and does not need to prepare specific viewing devices for different types of liquid crystal display devices, hence saving extra costs. The optical film can be adhered onto the liquid crystal display device by the adhesive layer, and thus is easy for use. Compared with the conventional method of FIG. 1, the display apparatus for displaying a 3D image of the invention has the advantages of convenience and cost saving.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display device, comprising:
a liquid crystal display device comprising a display panel and a polarizer disposed on the display panel;
an optical film disposed on the polarizer and for changing a polarization direction of a light emitted from the polarizer.

2. The display device according to claim 1, wherein the optical film comprises a retardation film.

3. The display device according to claim 1, wherein the optical film comprises a half wave plate.

4. The display device according to claim 3, wherein the polarizer has a first optical axis, the half wave plate has a second optical axis, the first optical axis and the second optical axis have an optical angle therebetween, the optical angle does not equal 0 degree.

5. The display device according to claim 4, wherein the optical angle equals 22.5 or 67.5 degrees.

6. A display apparatus for displaying a 3D image, comprising:
a liquid crystal display device, comprising:
a display panel; and
a first polarizer disposed on the display panel;
a half wave plate disposed on the first polarizer and for changing a polarization direction of a light emitted from the first polarizer; and
a viewing device comprising two viewing windows, wherein a surface of each of the viewing windows has a second polarizer.

7. The display apparatus for displaying a 3D image according to claim 6, wherein the first polarizer has a first optical axis, the half wave plate has a second optical axis, the second polarizer has a third optical axis, the first optical axis and the second optical axis have a first optical angle therebetween, the first optical axis and the third optical axis has a second optical angle therebetween, the second optical angle is larger than the first optical angle.

8. The display apparatus for displaying a 3D image according to claim 7, wherein the second optical angle is twice as much as the first optical angle.

9. The display apparatus for displaying a 3D image according to claim 8, wherein the first optical angle equals 22.5 or 67.5 degrees.

10. The display apparatus for displaying a 3D image according to claim 7, wherein:
the angle of the second optical axis equals 22.5 degrees as the angle of the first optical axis equals 45 degrees and the angle of the third optical axis equals 0 degree;
the angle of the second optical axis equals 67.5 degrees as the angle of the first optical axis equals 45 degrees and the angle of the third optical axis equals 90 degrees;
the angle of the second optical axis equals 67.5 degrees as the angle of the first optical axis equals 135 degrees and the angle of the third optical axis equals 0 degree;
the angle of the second optical axis equals 112.5 degrees as the angle of the first optical axis equals 135 degrees and the angle of the third optical axis equals 90 degrees;
the angle of the second optical axis equals 22.5 degrees as the angle of the first optical axis equals 0 degree and the angle of the third optical axis equals 45 degrees;
the angle of the second optical axis equals 67.5 degrees as the angle of the first optical axis equals 0 degree and the angle of the third optical axis equals 135 degrees;
the angle of the second optical axis equals 67.5 degrees as the angle of the first optical axis equals 90 degrees and the angle of the third optical axis equals 45 degrees; and
the angle of the second optical axis equals 112.5 degrees as the angle of the first optical axis equals 90 degrees and the angle of the third optical axis equals 135 degrees.

11. A method for changing a polarization direction of a light emitted from a liquid crystal display device, wherein the liquid crystal display device comprises a display panel and a polarizer disposed on the display panel, and the method comprises:
disposing an optical film on the display panel, the optical film is used for changing the polarization direction of the light emitted from the polarizer.

12. The method for changing the polarization direction of the light emitted from the liquid crystal display device according to claim 11, wherein the optical film comprises a retardation film.

13. The method for changing the polarization direction of the light emitted from the liquid crystal display device according to claim 11, wherein the optical film comprises a half wave plate.

14. The method for changing the polarization direction of the light emitted from the liquid crystal display device according to claim 13, wherein the polarizer has a first optical axis, the half wave plate has a second optical axis, the first optical axis and the second optical axis have an optical angle therebetween, the optical angle does not equal to 0 degree.

15. The method for changing the polarization direction of the light emitted from the liquid crystal display device according to claim 14, wherein the optical angle equals 22.5 or 67.5 degrees.
